(19) United States
(12) Patent Application Publication
(10) Pub. No.: US 2026/0314567 A1
(43) Pub. Date: Oct. 15, 2026

(54) CASE FOR A PET LEAD

(71) Applicant: Juan Pedro OSUNA ROMERO, Hermosillo (MX)

(72) Inventor: Juan Pedro OSUNA ROMERO, Hermosillo (MX)

(21) Appl. No.: 19/480,030

(22) PCT Filed: Feb. 20, 2024
(86) PCT No.: PCT/IB2024/051630

§ 371 Date: Oct. 30, 2025

(30) Foreign Application Priority Data
May 8, 2023 (ES) U202330792

(51) Int. Cl. A01K 27/00; A45F 5/02

(52) U.S. Cl. CPC A01K 27/003; A45F 5/021

(57) ABSTRACT

The case for a pet lead is formed by a main body (1) including a housing (1.1) into which the casing (2.1) of the lead (2) is inserted. The main body (1) includes an opening (1.2) through which the lead exits to the outside, and fastening means for attachment to the user's belt or clothing. In one embodiment, the main body (1) is made of textile material, although it may also be made of other types of materials. The fastening means is a loop (5) located on the outer face of the main body (1). The loop (5) may be used to attach the case to the user's belt.

### OBJECT OF THE INVENTION

The invention, as stated in the title of this descriptive report, relates to a case for a pet lead, which constitutes an innovation that, within current techniques, provides advantages that were previously unknown.

Thanks to its design and configuration, the case allows the insertion of a lead, of the type traditionally used for walking pets, particularly dogs, comprising a casing. In this way, the lead remains attached to the case. In turn, the case can be fastened to the user's belt or clothing, so that if the leash is dropped or slips from the hand, the dog or pet will not be able to run away, as the case will remain securely attached to the user.

### TECHNICAL FIELD

Therefore, the present invention falls within the field of manufacturing accessories for pets and their leads, whether retractable or not.

### BACKGROUND OF THE INVENTION

When taking pets for a walk, leads are generally used to control the maximum distance the pet can move away from the owner.

In urban environments, this is even mandatory, in order to prevent the pet from entering the roadway and causing an accident, or disturbing other pedestrians.

These leads typically include an ergonomic handle that allows the user to hold and carry the lead in their hand. However, this can be uncomfortable, as it means the pet owner always has one hand occupied, preventing them from performing other tasks.

Moreover, it is very common that, due to the pulling behavior of the pet—especially when running or walking faster than its owner—the lead may fall or slip from the owner's hand. This can result in an accident if the animal enters a roadway, and it may be difficult for the user to retrieve the lead.

With the aim of solving the aforementioned problems, the present invention is proposed.

To date, no product is known that presents the same technical characteristics as the invention described herein.

### DESCRIPTION OF THE INVENTION

The purpose of the present invention is the creation of a case for a pet lead that provides a significant innovation within its field of application and in view of the current state of the art, the characterizing details that make it possible being conveniently set forth in the final claims that accompany this description.

The main problem solved by this invention is the loss of control over the dog in the event the lead slips away. By being attached to the user's belt, the user can ensure that the dog remains under control at all times, thereby preventing potential accidents.

It also serves as a training aid, as it allows the user to keep their hands free.

### DESCRIPTION OF THE FIGURES

To complement the description being provided and in order to facilitate a better understanding of the features of the invention, the present descriptive report is accompanied—as an integral part thereof—by a figure that, in an illustrative and non-limiting manner, shows the following:

FIG. 1 is a perspective view of the case object of the invention.

FIG. 2 is a rear view of the case shown in FIG. 1.

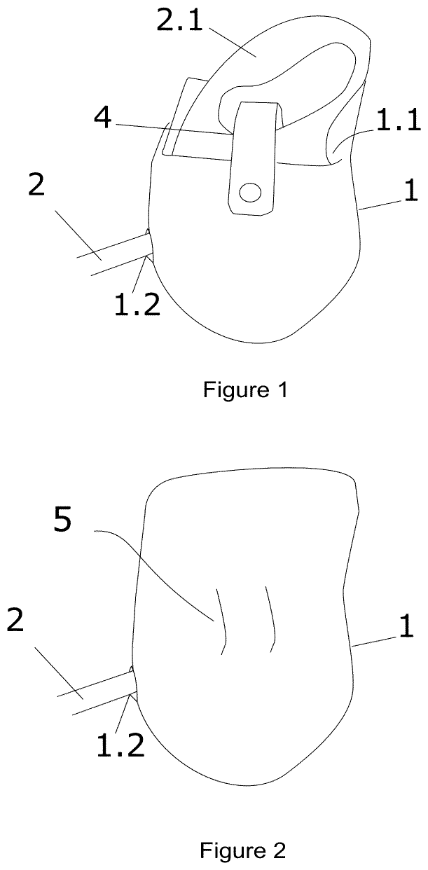

### PREFERRED EMBODIMENT OF THE INVENTION

The case for a pet lead is formed by a main body (1) including a housing (1.1) into which the casing (2.1) of the lead (2) is inserted. The main body (1) also includes an opening (1.2) through which the lead exits to the outside, as well as means for fastening to the user's belt or clothing.

In one embodiment, the main body (1) is made of textile material, although it may also be made of other types of materials.

The fastening means consists of a loop (5) located on the outer face of the main body (1). This loop (5) can be used to attach the case to the user's belt.

Preferably, the housing (1.1) includes a closure means (4) at its opening to prevent the casing with the lead from accidentally coming out.

The closure means (4) may consist of a textile element fixed to an inner face of the body and having, at its end, a snap fastener that engages with the female part of the snap fastener, which is fixed to the outer face of the body, on the opposite side of the housing (1.1).

Having sufficiently described the nature of the present invention, as well as the manner of implementing it, no further explanation is considered necessary for any expert in the field to understand its scope and the advantages derived therefrom. It is stated that, within its essential nature, the invention may be carried out in other embodiments that differ in detail from the one described by way of example, and such embodiments shall likewise fall within the scope of protection claimed, provided that the fundamental principle is not altered, changed, or modified.

1. A case for a pet lead, characterized in that it is formed by a main body (1) including a housing (1.1) into which the casing (2.1) of the lead (2) is inserted, the main body (1) further comprising an opening (1.2) through which the lead exits to the outside, and means for fastening to the user's belt or clothing.

2. The case for a pet lead according to claim 1, characterized in that the main body (1) is made of textile material.

3. The case for a pet lead according to claim 1, characterized in that the fastening means is a loop (5) located on the outer face of the main body (1).

4. The case for a pet lead according to claim 1, characterized in that the housing (1.1) includes a closure means (4) at its opening.
